(19) United States
(12) Patent Application Publication
(10) Pub. No.: US 2004/0201131 A1
(43) Pub. Date: Oct. 14, 2004

(54) Thread protection system and article of manufacture

(76) Inventors: H. Dean Goodson, Houston, TX (US); Robert D. Gibbens, Kingwood, TX (US); James G. Kelley, Crosby, TX (US)

Correspondence Address: Charles D. Gunter, Jr., Whitaker, Chalk, Swindle & Sawyer, LLP, 301 Commerce Street, STE 3500, Fort Worth, TX, 76102-4186, US

(21) Appl. No.: 10/412,157

(22) Filed: Apr. 11, 2003

(51) Int. Cl. B29D 23/00

(52) U.S. Cl. 264/220; 264/296; 264/319; 264/919; 138/96 T

(57) ABSTRACT

A method and system are shown for protecting the threaded ends of tubular goods such as oil field tubulars from physical damage and corrosion due to environmental factors. A thread protector is formed of a polymeric body having cylindrical wall portions which engage the threaded ends of the tubular goods. Instead of relying upon a separate thread compound or corrosion inhibitor applied to the exposed threads, the polymeric body has incorporated therein a corrosion inhibiting compound, which is integrally molded within the polymeric body as a part of the manufacturing process used to mold the polymeric body. The method also allows used end caps to be recycled into the corrosion resistant end caps of the invention.

### BACKGROUND OF THE INVENTION

A. Field of the Invention:

The present invention relates to a method and system for protecting the threaded ends of pipes, such as oil field tubular goods, from physical damage and corrosion by providing an end protector formed of a polymeric body with a corrosion inhibitor integrally molded therein and to a method for recycling used end protectors.

B. Description of the Prior Art

Drill pipe, tubing and casing (tubular goods) for oil and gas drilling, completion, production and stimulation activities are typically held in a storage or pipe yard after they have been received from the fabricator or returned from downhole use. A major industry has developed in protection of such oil field tubular goods to prevent them from corroding during periods of storage. The storage is not permanent, typically extending for a number of months or until a need arises for a specific size and grade of the tubular in question. The tubular goods are typically cleaned before storage in order to prepare them for shipment to the rig site at a future date. However, corrosion due to water and oxygen may quickly attack the precisely machined threads, which then cannot provide a satisfactory threaded connection. Pipe thread corrosion may be ordinary oxidation, or rust, or maybe aggravated by micro-organisms which feed on various materials on the surface of the thread, producing an acid which causes pitting of the threads.

The exposed threaded ends of tubular metal goods are conventionally protected by some sort of supplemental means in order to extend their storage life. For example, physical thread protectors in the form of plastic or elastomeric end caps or end caps made from metals such as steel, brass or copper have been placed on the threaded ends of tubular goods to provide protection from physical abuse and from corrosion. Chemical compositions which act as running compounds and/or corrosion inhibitors are also applied to the thread surface regions of the tubulars, which combined with thread protectors serve to function as a system to prevent impact and corrosion damage to the valuable and vital thread areas. For example, API (American Petroleum Institute) pipe dope (thread compound) is utilized, although it is generally low in corrosion inhibiting properties. Pipe dope is intended to be used as a running thread compound with lubricating and sealing properties. It is a thick grease based material which may contain lead, other heavy metals and filler materials to seal the thread passageways found in the threaded connection of oil field tubular goods. An example of a storage compound as opposed to a thread compound is a product sold under the trademark KENDEX that is a wax based material which is only applied to prevent or inhibit corrosion. Other lighter materials, such as a light oil might be utilized as well if the pipe is to be used within a day or two of the time it is threaded.

While in some cases the applied compounds and solids are captured and recycled, they are sometimes allowed to be discharged into the environment, presenting the problems of hazardous waste containment and removal. Once the tubulars are threaded the manufacturer must apply either a pipe dope or storage compound then apply a thread protector to prevent corrosion and/or impact damage. OCTG threads are frequently subjected to a series of inspections once shipped from the manufacturer. These inspections require the removal of the thread protector and the applied compound. The compound on the thread protector and the threaded ends must be treated as hazardous waste and therefore present an expensive containment and removal problem.

Pipe dope compositions are less than an optimum solution as a storage compound since these products do not offer sufficient anti-corrosion properties and often contain hazardous materials such as lead, copper, zinc, and hydrocarbons. Storage compounds cannot be used as an API thread running compound as they do not exhibit sufficient lubricity properties, sealing properties and must be cleaned from the threaded connection thoroughly before the API thread compound and sealant is employed.

The mechanical end caps or thread protectors have traditionally functioned primarily to protect the threads against impact damage if the pipe is accidentally dropped or bumped. Many of the prior art thread protectors are loose fitting “dust covers” and are of little value in preventing impact damage or the intrusion of moisture into the thread region. Certain of the prior art designs are “cup-shaped” and thus offer a tighter fit and incorporate moisture seals, such an O-rings, in an effort to improve corrosion protection.

The prior art end caps are generally removed near the well site and often are contaminated with immersed crude oil, pipe dope, drilling mud and accumulated tars and lighter oils that are found on the drill site. As a result, recycling the plastic or elastomeric polymers making up the prior art end caps has been economically unfeasible in many instances due to the cost of cleaning the waste polymer pieces for recycle processing.

A need exists for an improved end cap for protecting the threaded ends of oil field tubular goods from physical damage and corrosion which eliminates the need for pipe dopes, greases, heavy metal constituents, or hazardous materials used in the past.

A need also exists for such an end cap which has incorporated therein a corrosion inhibiting compound, the compound being integrally molded within the polymeric body.

A need also exists for an improved end protector composition which can be easily and economically recycled by eliminating the need of much of the cost of cleaning waste polymer pieces before recycle processing.

### SUMMARY OF THE INVENTION

An improved thread protector is provided for tubular goods having threaded ends such as oil field tubular goods. The improved thread protector is formed of a polymeric body having cylindrical wall portions which engage the threaded ends of the tubular goods in order to protect the threaded ends from physical abuse as well as isolating the threaded ends from environmental corrosion. The polymeric body has incorporated therein a corrosion inhibiting compound, the compound being integrally molded within the polymeric body.

The polymeric body can be formed of a variety of conveniently available materials commonly used in the industry including polyethylene, polypropylene, high density polyethylene, polyurethane, polyvinylchloride, styrene-butadiene copolymers, acrylics and polycarbonates. The corrosion inhibitor which is incorporated within the polymeric body has a characteristic flash point which is selected to be above a mold temperature used to mold the polymeric body. Preferably, the polymeric body has incorporated therein from about 1 to 20% corrosion inhibitor by weight, based upon the total weight of the polymeric body.

In a typical application, a sealant composition is first applied to the threaded ends of the tubular. The thread protector, in the form of a physical end protector, is then installed on the threaded end of the tubular. The end protector is a polymeric body having a corrosion inhibitor integrally molded within the polymeric body and having cylindrical wall portions which engage the threaded ends of the tubular goods in order to protect the threaded ends from physical abuse as well as isolating the threaded ends from environmental corrosion.

A method of recycling used end caps used to protect threaded ends of oil field tubular goods is also described. A source of used end caps is first collected at a central location. The used end caps will typically have field residue remaining on the end caps. The used end caps are first shredded and ground to a desired particle size. The particles are then conveyed to a thermokinetic blender which mixes the particles at elevated temperatures to form a polymeric product. The polymeric product is discharged into a suitable mold which forms a molded polymeric product having cylindrical walls. The molded polymeric product is discharged from the mold and selected portions of the cylindrical walls thereof are threaded, whereby the threaded selected portions of the cylindrical walls matingly engage a selected end of the oil field tubular goods. The mold temperature used to mold the polymeric bodies is typically in the range from about 300-400° F. The polymeric bodies will have incorporated therein from about 1 to 20% corrosion inhibitor by weight, based upon the total weight of the polymeric body.

Additional objects, features and advantages will be apparent in the written description which follows.

### BRIEF DESCRIPTION OF THE DRAWINGS

FIG. 1 is a partial, end view of the pin end of an oil field tubular showing an end protector of the invention in place thereon.

FIG. 2 is a view similar to FIG. 1 but showing a corresponding box end of an oil field tubular showing the end protector of the invention in place.

FIG. 3 is a simplified, schematic view of a method for recycling used end caps into the corrosion resistant protectors of the invention.

### DETAILED DESCRIPTION OF THE INVENTION

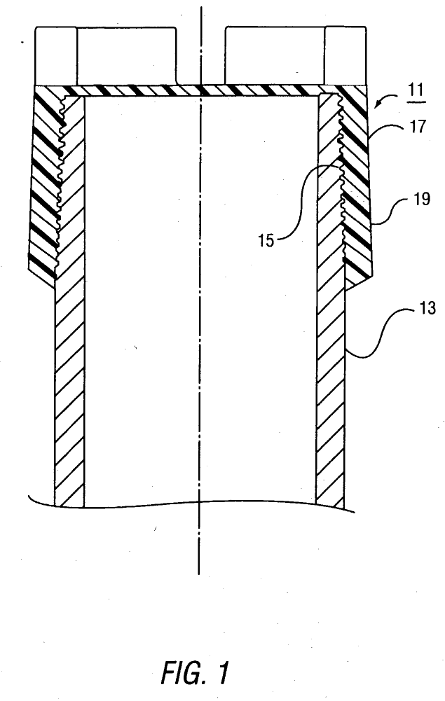

Referring now to FIG. 1 of the drawings, there is shown an improved thread protector 11 for a section of oilfield tubular goods, in this case, pin end 13 of a section of oil field casing. The tubular 13 has an externally threaded outer extent 15. The thread protector 11 includes a polymeric body 17 having cylindrical wall portions 19 which engage the threaded outer extent 15 of the tubular 13 in order to protect the threaded end from physical abuse as well as isolating the threaded end from environmental corrosion. In the discussion which follows, the term “polymeric body” is intended to encompass plastic, elastomeric and synthetic polymeric materials of the type typically utilized in the industry for end caps. The preferred polymeric body is formed from a material selected from the group consisting of polyethylene, polypropylene, high density polyethylene, polyurethane, polyvinylchloride, styrene-butadiene copolymers, acrylics and polycarbonates. A particularly preferred material for the polymeric body is high density polyethylene.

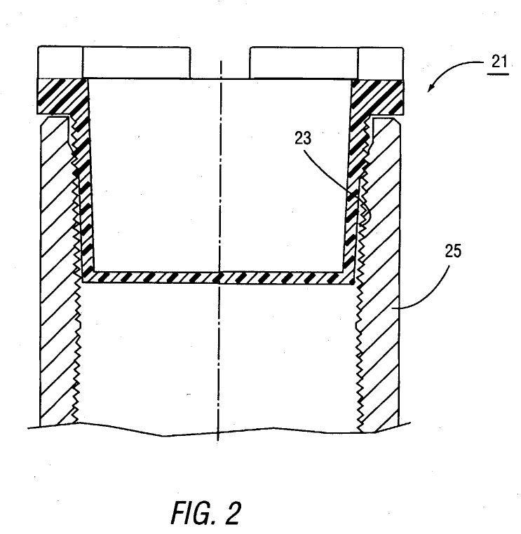

The end cap or thread protector 11 illustrated in FIG. 1 has internally threaded cylindrical sidewalls which engage the externally threaded pin end of the tubular 13. FIG. 2 shows a cup-shaped thread protector 21 which has externally threaded sidewalls for engaging the internally threaded, box end 25 of the tubular. The polymeric end cap protectors illustrated in FIGS. 1 and 2, which are examples of the Hunting Composite Gold Series protectors for API tubing, are typical of the prior art thread protectors in shape and overall function. Other typical examples of thread protectors commercially available from Hunting Composite of Houston, Tex., are the Hunting Composite Thread Protectors for API Casing and Tubing that are molded from high-density polyethylene, are covered by a protective steel shell, and are designed to cover the full thread length. The Hunting Composite Platinum Series Thread Protectors are also molded from high density polyethylene and compliment premium threads and sealing surfaces.

The thread protectors of the invention differ from the prior art in that the polymeric body 17 has incorporated therein a corrosion inhibiting compound which is integrally dispersed and molded within the polymeric body 17. In one preferred embodiment to be described, the improved thread protectors of the invention are formed by recycling used end caps. A number of commercially available corrosion inhibitors can be utilized in the method of the invention. The preferred corrosion inhibitor has a characteristic flash point with the flash point being selected to be above a mold temperature to mold the polymeric body. For example, one commercially available inhibitor is sold under the trade name NaSul 729 by King Industries of Norwalk, Conn. This inhibitor has a sulfonate percentage of 51.2% as measured by ASTM D 3049; a viscosity of 81.6 CPS as measured by ASTM D 445; a flash point of 160° C. (320° F.) and a specific gravity of 0.980 as measured by ASTM's D 4052.

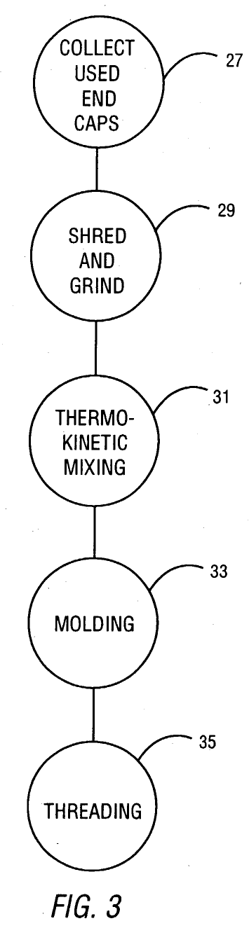

The corrosion inhibitor is typically present in the range from about 1 to 20% by weight, preferably about 5 to 15% by weight based on the total weight of the polymeric components. FIG. 3 is a simplified schematic which illustrates a preferred method of forming the thread protectors of the invention. In a particularly preferred embodiment, the thread protectors are manufactured by recycling used end caps which have been collected in a step 27. The end caps can then be fed to a shredding and grinding step or steps 29 in which the end caps are reduced in size. The size of the shredded and ground particles is not critical but is typically on the order of 0.25-0.5 inches and may be pulverized to about 35 mesh or even to 100 mesh or finer. The ground up material is then fed to a thermokinetic mixer in step 31. The corrosion inhibitor (and other materials) can conveniently be blended during the thermokinetic mixing step 31. Since the compounder heats the materials in the range from about 300-400° F., the corrosion inhibitor should have a flash point above the expected compounding temperature.

Thermokinetic compounders are described, for example, in issued U.S. Pat. No. 5,895,790 to Good, issued Apr. 20, 1999. This reference describes a thermokinetic compounder which can be used for melt blending. The device economically recovers polymer blends and waste thermoset material into useful products by first preforming a thermoset material from disparate polymers and then melt blending the thermoset material with a thermoplastic material into useful products. The same type apparatus can be utilized in melt blending the used end caps of the invention, even where contaminated with oils and other oil field materials.

In the thermokinetic mixing process, polymer is loaded within a chamber where a shaft with widely spaced projections spins at speeds on the order of 4000 rpm, shearing and fracturing pieces of polymer and impinging them upon the inside wall of the chamber. While some thermokinetic mixers raise the temperature of polymers from ambient to as much as 620° F. in 20 to 25 seconds or less, the present method contemplates operating at temperatures on the order of about 320° F. or lower in order to prevent flashing of the corrosion inhibitor. This temperature will vary with the flash point of the selected inhibitor compound.

In the next step in the method, the molten batch is released from the chamber of the thermokinetic mixer 31, preferably into a mold shown at step 33 in FIG. 3. The mold can conveniently be a two part mold operated by a hydraulic press provided with a water coolant cycle. Typical dwell time is on the order of five minutes at which point the mold halves are pulled apart and the pieces are removed. The molded end caps are then threaded on a lathe to the appropriate thread form in a step illustrated as 35 in FIG. 3.

Once manufactured, the thread protectors of the invention can be utilized in the customary fashion in the industry with the exception that a thread dope or heavy grease is not generally required. A light sealant composition may be applied to the threaded ends of the tubular, if desired. In a typical operation, the cut part is first inspected and accepted. A water displacement composition such as CRC 336, WD-40 or bactericide may be utilized in the cutting fluid. The product may then have a slight sealant applied such as the PRESERVE-A-THREAD product from Hunting Composite of Houston, Tex. The PRESERVE-A-THREAD compound is a corrosion inhibitor which can be sprayed or brushed onto the threads. The formulation contains no phosphates and is non-toxic, anti-microbial and biodegradable and recleaning prior to running the tubular is not generally necessary. The thread protectors of the invention can then be screwed into engagement on the pipe ends.

An invention has been provided with several advantages. The thread protectors of the invention do not require typical thread dope compounds to provide moisture and corrosion protection. Because thread dope compounds containing hazardous materials are not required, the used end protectors can be more easily recycled and pose less danger of environmental contamination. The thread protectors of the invention can be used with a light sealing composition and do not require harsh solvents of the type used to clean traditional dope compounds. The thread protectors of the invention offer the same degree of corrosion protection while utilizing more environmentally friendly materials. The thread protectors can be recycled for reuse even with field residue present. Because of the thermokinetic mixing process, heavy metals or other contaminants are encapsulated within the polymeric body and do not tend to leach into the environment.

While the invention has been shown in one of its forms, it is not thus limited and is susceptible to various changes and modifications without departing from the spirit thereof

I claim:

1. An improved thread protector for tubular goods having threaded ends, the improved thread protector comprising:
a polymeric body having cylindrical wall portions which engage the threaded ends of the tubular goods in order to protect the threaded ends from physical abuse as well isolating the threaded ends from environmental corrosion;
wherein the polymeric body has incorporated therein a corrosion inhibiting compound, the compound being integrally molded within the polymeric body.

2. The improved thread protector of claim 1, wherein the polymeric body is formed from a material selected from the group consisting of polyethylene, polypropylene, high density polyethylene, polyurethane, polyvinylchloride, styrene-butadiene copolymers, acrylics and polycarbonates.

3. The improved thread protector of claim 1, wherein the polymeric body is an end cap with internal sidewalls which contact an externally threaded pin end of the tubular goods.

4. The improved thread protector of claim 1, wherein the polymeric body is a cup shaped member with external sidewalls which contact an internally threaded box end of the tubular goods.

5. The improved thread protector of claim 1, wherein the corrosion inhibitor has a characteristic flash point and wherein the flash point is selected to be above a mold temperature used to mold the polymeric body.

6. The improved thread protector of claim 1, wherein the polymeric body has incorporated therein from about 1 to 20% corrosion inhibitor by weight, based upon the total weight of the polymeric body.

7. In combination with an oil field tubular having threaded ends,
a sealant composition applied to the threaded ends;
an end protector comprising a polymeric body having cylindrical wall portions which engage the threaded ends of the tubular goods in order to protect the threaded ends from physical abuse as well isolating the threaded ends from environmental corrosion;
wherein the polymeric body has incorporated therein a corrosion inhibiting compound, the compound being integrally molded within the polymeric body.

8. The combination of claim 7, wherein the sealant composition is a liquid solution.

9. The combination of claim 7, wherein the sealant is a thread compound or grease.

10. The combination of claim 7, wherein the corrosion inhibitor has a characteristic flash point and wherein the flash point is selected to be above a mold temperature used to mold the polymeric body.

11. The combination of claim 7, wherein the polymeric body has incorporated therein from about 1 to 20% corrosion inhibitor by weight, based upon the total weight of the polymeric body.

12. A method of manufacturing a thread protector for tubular goods having threaded ends, the method comprising the steps of
molding a polymeric body having cylindrical wall portions which engage the threaded ends of the tubular goods in order to protect the threaded ends from physical abuse as well isolating the threaded ends from environmental corrosion;
wherein the polymeric body has incorporated therein a corrosion inhibiting compound, the compound being integrally molded within the polymeric body.

13. The method of claim 12, wherein the polymeric body is formed from a material selected from the group consisting of polyethylene, polypropylene, high density polyethylene, polyurethane, polyvinylchloride, styrene-butadiene copolymers, acrylics and polycarbonates.

14. The method of claim 12, wherein the corrosion inhibitor has a characteristic flash point and wherein the flash point is selected to be above a mold temperature used to mold the polymeric body.

15. The method of claim 14, wherein the mold temperature used to mold the polymeric body is in the range from about 300-400° F.

16. The method of claim 12, wherein the polymeric body is formed by mixing waste polymeric materials, and/or new polymeric materials, in a thermokinetic compounder/mixer at elevated temperatures to form a polymeric product, followed by discharging the polymeric product into a suitable mold.

17. The method of claim 12, wherein the polymeric body has incorporated therein from about 1 to 20% corrosion inhibitor by weight, based upon the total weight of the polymeric body.

18. A method of recycling used end caps used to protect threaded ends of oil field tubular goods, the method comprising the steps of:
collecting a source of used end caps at a central location which have field residue remaining thereon;
shredding and grinding the used end caps to thereby reduce them to particle size;
conveying the particles to a thermokinetic blender which mixes the particles at elevated temperatures to form a polymeric product, followed by discharging the polymeric product into a suitable mold which forms a molded polymeric product having cylindrical walls;
discharging the molded polymeric product from the mold and threading selected portions of the cylindrical walls, whereby the threaded selected portions of the cylindrical walls matingly engage a selected end of the oil field tubular goods.

19. The method of claim 18, wherein the polymeric body is formed from a material selected from the group consisting of polyethylene, polypropylene, high density polyethylene, polyurethane, polyvinylchloride, styrene-butadiene copolymers, acrylics and polycarbonates.

20. The method of claim 18, wherein the corrosion inhibitor has a characteristic flash point and wherein the flash point is selected to be above a mold temperature used to mold the polymeric body.

21. The method of claim 20, wherein the mold temperature used to mold the polymeric body is in the range from about 300-400° F.

22. The method of claim 12, wherein the polymeric body has incorporated therein from about 1 to 20% corrosion inhibitor by weight, based upon the total weight of the polymeric body.
